(19) United States
(12) Patent Application Publication
(10) Pub. No.: US 2016/0219894 A1
(43) Pub. Date: Aug. 4, 2016

(54) A NOVEL ALL NATURAL LOW FAT CHEDDAR CHEESE

(71) Applicants: Morsi Abou El Soda, Alexandria (EG); SCIENCE AND TECHNOLOGY DEVELOPMENT FUND, Cairo (EG)

(72) Inventor: Morsi Abou El Seoud El Soda, Alexandria (EG)

(73) Assignees: Science and Technology Development Fund, Cairo (EG); Morsi Abou EL SODA, Alexandria (EG)

(21) Appl. No.: 15/026,106

(22) PCT Filed: Sep. 25, 2014
(86) PCT No.: PCT/EG2014/000025

§ 371 Date: Mar. 30, 2016

(30) Foreign Application Priority Data
Oct. 2, 2013 (EG) 2013101536

(51) Int. Cl. A23C 19/032; A23C 19/14; A23C 19/072

(52) U.S. Cl. CPC A23C 19/0323; A23C 19/072; A23C 19/14; A23Y 2220/63

(57) ABSTRACT

Low fat cheeses often suffer from undesirable texture and flavor. The objective of this invention is to improve the yield, texture, flavor and quality of low fat Cheddar cheese during ripening using exopolysaccharides producing lactobacilli and ripening cultures. The invention represents one of the first attempts to tackle both texture and flavor at the same time. The invention reveals the effect of aging on the texture and flavor of low fat Cheddar cheese over a ripening period of six months. The cheese manufactured with a modified protocol using EPS-producing cultures and ripening cultures showed higher values for moisture content (45%) and yield (9.4%) when compared to cheese manufactured with the conventional procedure and without the addition of EPS producing cultures and ripening cultures (37.7%) and (4.9%) respectively. The obtained results indicated a 70% decrease in the fat content of the cheese. Texture profile analysis (TPA) indicated that the hardness, the cohesiveness, the springiness, the gumminess and the chewiness of the cheeses made using the EPS-producing cultures decreased with aging. The texture of the ripened low fat cheese made using EPS producing cultures was described as chewy, springy, cohesive and smooth. The use of the ripening cultures resulted in the elimination of the bitter flavor defect which is a common problem in low fat Cheddar.

### FIELD OF THE INVENTION

In today's food market, there is a significant demand for low-fat “all natural products”. Consumers are more concerned with healthy food, due to the increasing health problems associated with imbalances in food intake. Low fat cheese such as cheddar cheese has the priority among dairy products.

### BACKGROUND OF THE INVENTION

Prevalence of diseases of affluence (obesity, heart disease and certain cancers) associated with imbalances in food intake and sedentary lifestyles have prompted governments to promote dietary guidelines containing nutrition and dietary information for the general public. The dietary guidelines recommend a reduction in total dietary fat to 30% of total energy. As such, consumer awareness of dietary fat has increased and consequently the demand for low fat foods, including cheese, has grown substantially. The largest market for low and reduced fat foods is in the United States. While low fat cheese has gained some popularity, the consumer is demanding better-flavored products. Although there is enormous potential for growth in the low fat cheese market, the development of this market over the past 20 years has been slow due to poor consumer perception of low fat products that are considered inadequate in terms of both taste and texture. Difficulties arise when attempts are made to produce low fat variants of cheeses that are popular and established in the market as full fat varieties. In producing low fat variants of standard fat cheeses such as Cheddar, processing parameters must be altered substantially in order to produce an acceptable texture. The ratio of moisture to casein, the pH and salt in moisture, all factors that influence the biochemical and microbiological changes and which control flavor and texture development, differ substantially from full fat cheeses. The ripening characteristics differ between full, reduced and low fat variants, leading to substantial differences in flavor and texture, which in turn impacts consumer acceptance. Optimizing the textural character of low fat Cheddar while maintaining good flavor has proved to be technologically challenging.

Low-fat Cheddar cheeses, is frequently perceived as being dry, excessively firm and difficult to masticate. The cheese has low flavor intensity and off-flavors such as bitter and unclean/barnyard taste dominated the flavor profile. Different approaches to eliminate such defects have been applied which include:

The use of full fat manufacture protocol (Full fat Cheddar cheese is made from 3% fat. Pasteurized milk warmed at 30° C. and inoculated with the starter culture, and then Calcium Chloride is added followed by rennet to coagulate the milk in 30 min. The coagulum is then cut and the temperature gradually raised to 30° C. (0.2° C./min). Whey is then drained and the curd cheddared for 110 min until the pH reached 5.3±0.5, milled, dry salted and pressed overnight. Cheese is ripened at 8° C., 85% relative humidity) to produce low fat Cheddar cheese resulted in the production of a cheese that is too hard. In full fat Cheddar, the casein gel network entraps fat and moisture. Removal of fat from the casein network in low fat cheese had resulted in formation of a much tighter paracasein network, which on syneresis becomes excessively firm. Different approaches to enhance moisture content had been used including the manipulation of scald temperatures, stir times and temperatures (Banks et al., 1989), the use of curd washing, or dry stirring as opposed to curd milling (Johnson and Chen, 1995) or milling curd at a higher pH (Guinee et al., 1998). Reduction of fat in milk for Cheddar cheese manufacture had resulted in different changes in the flavor.

Use of stabilizers, fat replacers, sweet buttermilk and addition of granular soy lecithin to improve texture was noted to contribute off-flavor development, but the low fat cheese obtained was not follows the “all-natural product”.

Exopolysaccharides producing cultures had been suggested for low-fat Cheddar cheese making for several reasons. They have the ability to bind water and to increase the moisture in the nonfat substance (MNFS). This is an important function because fat reduction results in lower MNFS. The MNFS plays a major role in texture development. To increase the moisture in low-fat Cheddar cheese by reducing cooking temperature and drain the whey at a higher pH value, might have a negative effect on cheese flavor development (Mistry, 2001). In addition, increasing moisture might result in increased levels of free moisture in cheese and produce pasty, difficult to shred cheeses. Exopolysaccharides increase moisture retention by water binding or entrapment within their 3-dimensional network. In addition, EPS seem to act as nuclei for the formation of large pores in cheese. Exopolysaccharides also increase the viscosity of the aqueous phase in cheese and modify its flow characteristics. In addition, EPS interfere with protein-protein interactions physically or through their interaction with proteins.

Several studies highlighted the positive effect of EPS producing cultures on the physical and functional properties of reduced-fat Cheddar cheese (Awad et al., 2005a,b; Dabour et al., 2005, 2006; Hassan and Awad, 2005; Hassan et al., 2005).

Using of the ripening cultures to enhance flavor formation: these cultures exhibiting specific peptidase activities to reduce bitter flavor formation and produce the characteristic Cheddar flavor profile.

In the current invention, we introduce a novel strategy where we combined three different solutions:
1—Bring changes to the manufacturing process which included size of cubes after cutting, cooking temperature, speed and rate of stirring, the use of higher pH during the cheddaring and milling processes and pressure of pressing.
2—Addition of two EPS producing cultures which were described as ropy, capsular exopolysaccharides producing type cultures.
3—Addition of ripening cultures exhibiting a complex and diverse peptidase and esterase system.

### SUMMARY OF THE INVENTION

Low fat cheeses often suffer from undesirable texture and flavor. The objective of this invention is to improve the yield, texture, flavor and quality of low fat Cheddar cheese during ripening using exopolysaccharides producing lactobacilli and ripening cultures. The invention represents one of the first attempts to tackle both texture and flavor at the same time. The invention reveals the effect of aging on the texture and flavor of low fat Cheddar cheese over a ripening period of six months. The cheese manufactured with a modified protocol using EPS-producing cultures and ripening cultures showed higher values for moisture content (45%) and yield (9.4%) when compared to cheese manufactured with the conventional procedure and without the addition of EPS-producing cultures and ripening cultures (37.7%) and (4.9%) respectively. The obtained results indicated a 70% decrease in the fat content of the cheese. Texture profile analysis (TPA) indicated that the hardness, the cohesiveness, the springiness, the gumminess and the chewiness of the cheeses made using the EPS-producing cultures decreased with aging. The texture of the ripened low fat cheese made using EPS-producing cultures was described as chewy, springy, cohesive and smooth. The use of the ripening cultures resulted in the elimination of the bitter flavor defect which is a common problem in low fat Cheddar.

### BRIEF DESCRIPTION OF THE DRAWINGS

FIG. 1 shows, on the right hand side, the low fat Cheddar cheese made using the modified protocol and without the addition of exopolysaccharides producing cultures and ripening cultures, which can be described as crumbly and dry, while the cheese on the left hand side of the image shows the low fat Cheddar cheese made using the modified protocol and with the addition of exopolysaccharides producing cultures and ripening cultures, which can be described as smooth and cohesive which reflect the positive role of the two groups of cultures; and

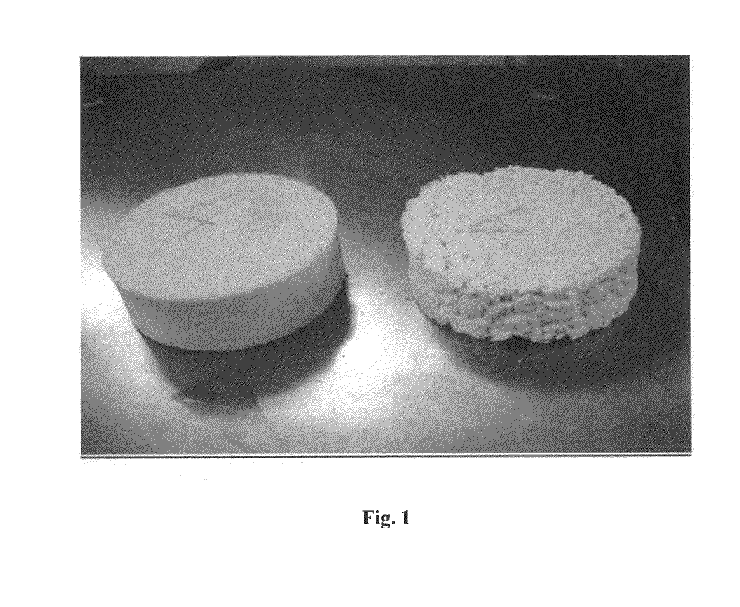

FIG. 2 is a flow sheet of low fat cheese making made using the modified protocol and the addition of exopolysaccharides cultures and ripening cultures.

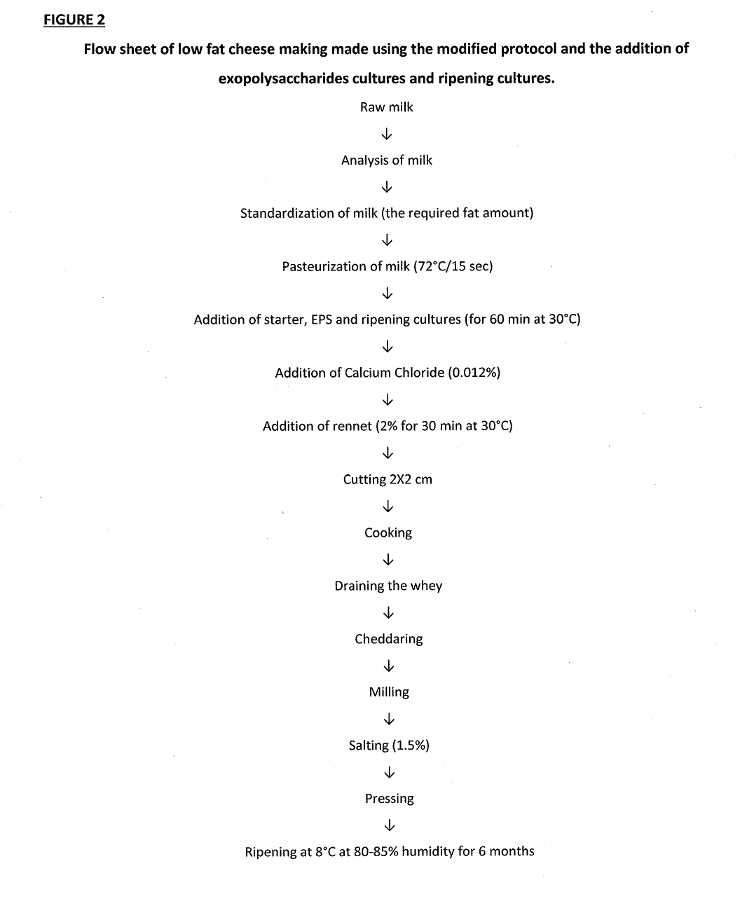

### DETAILED DISCLOSURE OF INVENTION

The detailed description for the production of “all natural” low fat Cheddar cheese using exopolysaccharides producing cultures and ripening cultures included the following steps:

Milk standardization: Raw milk is standardized to the required fat amount.

Milk heat treatment: Raw milk is pasteurized at 72° C. for 15 sec in a tubular pasteurization system.

Addition of starters: A mixture of the following microorganisms was added to cheese milk preheated to 30° C. Commercial starter culture containing a mixture of Lactococcus lactis subsp lactis and Lactococcus lactis subsp cremoris was used. A 1:1 mixture of two selected exopolysaccharides producing cultures identified as Lactobacillus delbrueckii subsp lactis and Lactobacillus paraplantarum were also added. Both lactobacilli were classified as capsular, ropy, and unattached. Strings of about 10 mm were formed by the previously mentioned Lactobacilli when their colonies were touched with a wire-inoculating loop.

The ripening cultures added to enhance flavor formation were composed of a 1:1 mixture of two strains of Lactobacillus paracasei subsp paracasei with the following specifications: the peptidase system of the two Lactobacillus paracaesi subsp paracasei is composed of an aminopeptidase N, three dipeptidases, an X-prolyldipeptidyl-peptidase as well as a carboxypeptidase and a specific endopeptidase. A general caseinolytic activity hydrolyzing both αS₁ and β-casein were also detected. Several esterases releasing C4, C6 and C8 fatty acids were also found in these strains.

Manufacture of low fat Cheddar cheese using the modified protocol: After the addition of the previous mixture of cultures, sufficient rennet was added at 30° C. for 30 min to form a smooth homogenous curd. Curd was then cut into 2×2 cm cubes to hold more moisture; the cubes were then cooked in the whey for 55 min by increasing the temperature 3° C. below the temperature used for the regular cooking of Cheddar cheese. The whey was removed and the curd cubes, acquiring more lactic acid, mat together into a cohesive mass, which was then cut into distinct blocks. The curd was then milled and cut into fine pieces and salted to reach 1.5% in the finished cheese. Salted curd was pressed at 1.5 bars in the first hour and increase pressure to 2.5 bars for 12 hours to give the cheese a close-texture. Cheese was ripened at temperature of 8° C. and a relative humidity of 85% for 6 months.

Texture profile analysis (TPA): Textural properties of cheese were evaluated using a texture analyzer (TA1000, Lab Pro (FTC TMS-Pro), USA). Cheese samples were cut into 30 mm³ cubes, samples were allowed to stand at ambient temperature for at least 1 h before testing. A two-bite penetration test was performed and operated at a crosshead speed 50 mm/sec. Hardness, cohesiveness, springiness, gumminess and chewiness were evaluated in triplicate described by Szczesniak et al (1963) and Bourne (1978).

Sensory evaluation: All samples were carried out in duplicate and all analysis was done in triplicate. Statistical analyses were performed with Fisher's least-significant differences and LSD procedures available with the SAS software package, 2008 with a considered significant at P<0.05. Significant differences between treatments were tested by ANOVA.

Discussion of results: The obtained results concerning the composition of Cheddar cheese (table 1) revealed that decreasing the fat content of cheese milk resulted in an increase in cheese moisture and protein and a decrease in cheese yield. Our results clearly indicated that low fat Cheddar cheese made with the EPS producing culture showed higher moisture and yield than this made without the addition of the EPS producing cultures. The low fat Cheddar cheeses made with the EPS producing cultures retained 4 to 5% higher moisture over low fat control cheese. The yield of EPS producing culture cheeses was 2.5 to 3% higher than that made without the addition of the EPS producing cultures and 0.7% to 0.9% lower than that the full fat cheese. The level of fat ranged from 10% to 11% in the EPS low fat cheeses. The fat content was 33% in the full fat Cheddar cheese. No significant differences in pH were found between EPS low fat cheese and full fat cheese after four months of ripening.

The resulting results describing the texture profile analysis obtained from low fat Cheddar cheese manufactured in the presence and the absence of EPS producing cultures and adjuncts cultures. The obtained results showed that the EPS low fat Cheddar cheese revealed lower values of hardness, adhesiveness, chewiness and gumminess and higher values of cohesiveness and springiness when compared to the cheese made without the addition of the EPS producing cultures. Data related to the TPA of full fat control cheese is also reported. The rheological parameters of full fat Cheddar were compared to those of low fat cheese samples. The obtained data reveal 92% similarity between the two cheeses for the hardness, chewiness and gumminess while low fat cheese showed to be more cohesive and springy than full fat cheeses. This indicated that the EPS produced by these cultures could reduce the rigidity of the low fat cheese (Table 2).

Obtained results revealed that the EPS low fat cheese showed higher scores when compared to cheese made without the EPS and ripening cultures. The addition of the different ripening cultures led to a significant reduction of bitterness and contributed to the development of the typical cheddar notes. The best and more reproducible results were obtained with the cheese made using the combination of the EPS producing cultures and ripening cultures.

Low fat cheese made without the EPS and ripening cultures were crumbly, curdy, grainy and rubbery in addition to the bitter flavor. Addition of EPS producing cultures to the cheese milk led to a significant improvement in cheese texture; in fact the EPS cheese exhibited a softer texture with 90% similarity to full fat cheese (Table 3).

TABLE 1
Chemical analysis of low fat Cheddar cheese:

| | | Moisture % | Fat % | | Protein % | |
|---|---|---|---|---|---|---|
| Treatments | pH | wt/wt | wt/wt | Salt % | wt/wt | Yield % |
| Full fat control cheese | 5.14 | 37.14 | 33 | 1.8 | 27.23 | 10.2 |
| Low fat cheese made without EPS and | 5.29 | 42.02 | 10 | 1.8 | 40.12 | 6.1 |
| adjunct | | | | | | |
| Low fat cheese made without EPS and | 5.23 | 42.26 | 10 | 1.8 | 37.59 | 8.7 |
| with adjunct | | | | | | |
| Low fat cheese made with EPS and | 5.27 | 45.28 | 10 | 1.8 | 34.22 | 8.9 |
| without adjunct | | | | | | |
| Low fat cheese made with EPS and adjunct | 5.20 | 45.73 | 10 | 1.8 | 34.57 | 9.2 |

TABLE 2
Texture analysis of low fat Cheddar cheese:

| | Ripening | Hardness | Adhesiveness | Springiness | Cohesiveness | Chewiness | Gumminess |
|---|---|---|---|---|---|---|---|
| Treatments | period | (N) | (J) | (mm) | (ratio) | (J) | (N) |
| Full fat control | Zero time | 12.42 | 0.15 | 3.30 | 0.67 | 27.47 | 8.32 |
| cheese | 4 M | 11.91 | 0.14 | 3.34 | 0.64 | 25.46 | 7.62 |
| Low fat | Zero T | 31.62 | 0.26 | 3.11 | 0.42 | 49.14 | 15.80 |
| cheese made | 4 M | 27.71 | 0.20 | 3.05 | 0.40 | 35.04 | 11.49 |
| without EPS | | | | | | | |
| and adjunct | | | | | | | |
| Low fat | Zero T | 25.31 | 0.22 | 3.23 | 0.49 | 40.06 | 12.40 |
| cheese made | 4 M | 22.12 | 0.20 | 3.45 | 0.50 | 38.16 | 11.06 |
| without EPS | | | | | | | |
| and with | | | | | | | |
| adjunct | | | | | | | |
| Low fat | Zero T | 15.12 | 0.20 | 3.31 | 0.71 | 35.53 | 10.74 |
| cheese made | 4 M | 13.33 | 0.18 | 3.37 | 0.73 | 32.79 | 9.73 |
| with EPS and | | | | | | | |
| without | | | | | | | |
| adjunct | | | | | | | |
| Low fat | Zero T | 12.73 | 0.15 | 3.31 | 0.72 | 30.38 | 9.17 |
| cheese made | 4 M | 11.97 | 0.12 | 3.38 | 0.74 | 29.93 | 8.86 |
| with EPS and | | | | | | | |
| adjunct | | | | | | | |

TABLE 3
Sensory evaluation of low fat Cheddar cheese:

| | Ripening | | | | Rubbery/ | | | |
|---|---|---|---|---|---|---|---|---|
| Treatments | period | Acid | Bitter | Crumbly | firm | Smooth | Springy | Chewy |
| Full fat control cheese | Zero time | 1 | 0.5 | 2 | 1.5 | 7 | 2 | 4 |
| | 4 M | 2 | 0.5 | 1 | 0.7 | 9 | 1 | 1 |
| Low fat cheese made | Zero T | 2 | 6 | 7 | 6 | 0 | 0 | 9 |
| without EPS and adjunct | 4 M | 3 | 7 | 7 | 8 | 0 | 0 | 10 |
| Low fat cheese made | Zero T | 1 | 2 | 6 | 7 | 0 | 0 | 9 |
| without EPS and with | 4 M | 2 | 2 | 6 | 8 | 0 | 0 | 8 |
| adjunct | | | | | | | | |
| Low fat cheese made with | Zero T | 1 | 3 | 3 | 2 | 6 | 4 | 4 |
| EPS and without adjunct | 4 M | 2 | 5 | 3 | 1 | 7 | 7 | 2 |
| Low fat cheese made with | Zero T | 1 | 0.5 | 1 | 1 | 7 | 4 | 4 |
| EPS and adjunct | 4 M | 2 | 0.8 | 0 | 0.5 | 8 | 6 | 1 |

What distinguish our invention from previous attempts for the production of low fat cheese is the fact that we are combining three different strategies that are commonly used: modification to the make process which involves (size of cubes after cutting, cooking temperature, speed and rate of stirring, the use of higher pH during the Cheddaring and milling processes and pressure of pressing when compared to the values used during the manufacture of full fat Cheddar. The success of our invention is also due to the use of two groups of cultures; exopolysaccharides producing cultures for the improvement of the rheological characteristic of the low fat Cheddar cheese and ripening cultures exhibiting specific peptidase activities to reduce bitter flavor formation and produce the characteristic Cheddar flavor profile. These cultures are part of our laboratory culture bank.

The low fat cheese obtained follows the “all-natural” range of products since non-dairy ingredients such as fat replacers; stabilizers, sweet buttermilk and addition of granular soy lecithin are not used.

Expected users: The USA is the world highest producer of Cheddar cheese. It is also the largest market for low and reduced fat foods. We therefore think that the USA is the best market of our invention. The commercialization of the invention can be done through:

Large dairy companies equipped with research and development facilities; and

The starter producer companies.

To insure the success of the invention, it is important to apply our recipe on milk produced in the USA and have American scientists and consumer carry out a sensory evaluation of cheese.

### REFERENCES

Fenelon, M. A., & Guinee, T. P. (2000). Flavor development in low-fat cheese. In Cogan, T. M. (Ed.), Proceedings of the sixth Moorepark Cheese symposium (pp. 31-42). Dublin: Teagasc.

Dexheimer, E. (1992). On the fat track. Dairy Foods, 93(5), 38-50.

Barr, A. (1990). Consumer motivational forces affecting the sale of light dairy products. Food Technology, 44, 97-99.

Olson, N. F., & Johnson, E. (1990). Light cheese products: characteristics and economics. Food Technology, 44, 90-93.

Coulson, J., Pawlett, D., & Wivell, R. (1991). Cutting fat, keeping flavour. Dairy Industries, 56(7), 31-32.

Broadbent, J., Brennand, C., Jonson, M. E., Steele, J. L., Strickland, M., Weimer, B. (1997). Starter contribution of reduced fat Cheddar. Dairy Industries International, 62 (2), 35, 37, 39.

Emmons, D. B., Kalab, M., & Larmond, E. (1980).Milk gel structure. X. Texture and microstructure in Cheddar cheese made from whole milk and from homogenized low-fat milk. Journal of Texture Studies, 11, 152-159.

Jameson, G. W. (1990). Cheese with less fat. Australian Journal Dairy Technology, 45, 93-98.

Muir, D. D., Banks, J. M. and Hunter, E. A. (1992) Sensory changes during maturation of fat-reduced Cheddar cheese: Effect of addition of enzymatically active attenuated cultures. Milchwissenschaft, 47, 218-222.

Awad, S., Hassan, A. N. and Halaweish, F. (2005a) Application of exopolysaccharide-producing cultures in reduced fat Cheddar cheese. Composition and proteolysis. Journal of Dairy Science, 88, 4195-4203.

Awad, S., Hassan, A. N. and Muthukumarappan, K. (2005b) Application of exopolysaccharide-producing cultures in reduced-fat Cheddar cheese. Texture and melting properties. Journal of Dairy Science, 88,4204-4213.

Dabour, N., Kheadr, E. E., Benhamou, E., Fliss, I. and LaPointe, G. (2006) Improvement of texture and structure of reduced-fat Cheddar cheese by exopolysaccharide-producing lactococci, Journal of Dairy Science, 89,95-110.

Hassan, A. N. and Awad, S. (2005) Application of exopolysaccharide producing cultures in reduced-fat Cheddar cheese. Cryo-scanning electron microscopy observations. Journal of Dairy Science, 88, 4214-4220.

Agrawal, P. and Hassan, A. N. (2007) Ultrafiltered milk reduces bitterness in reduced-fat Cheddar cheese made with an exopolysaccharide-producing culture. Journal of Dairy Science, 90, 3110-3117.

Fenelon, M. A., Guinee, T. P. and Reville, W. J. (1999) Characteristics of reduced fat Cheddar prepared from blending full fat and skim cheese curds at whey drainage, Milchwissenschaft, 54, 506-510.

El Soda, M., Madkor, S. A. and Tong, P. S. (2000) Adjunct Cultures: Recent developments and potential. Significance to the Cheese. Industry Journal of Dairy Science, 83, 609-619.

Robinson, R. K. and Wilbey, R. A. (1998) Cheese making Practice, R. Scott. The University of reading, UK, An Aspen Publication, Aspen Publishers, Inc. Gaithersburg, Md.

Association of Official Analytical Chemists (2003) Official Methods of Analysis. 17th ed. AOAC, Gaithersburg, Md.

Bourne, M. (1978) Texture Profile Analysis. Food Technology, 32: 62-66, 72.

Szczesniak, A., Brandt, M. and Freidman, H. (1963) Development of standard rating scales for mechanical parameters and correlation between the objective and sensory texture measurements. Food Technology, 22: 50-54.

Mistry V. V. (2001) Low fat cheese technology, International Dairy Journal, 11, 413-422.

Guinee, T. P., Auty, M. A. E. and Fenelon, M. A. (2000) The effect of fat content on therheology, microstructure and heat-induced functional characteristics of Cheddar cheese. International Journal Dairy Technology, 10, 277-288.

Costa, N. E., Hannon, J. A., Guinee, T. P., Auty, M. A. E, McSweeney, P. L. H. and Beresford, T. P. (2010) Effect of exopolysaccharide produced by isogenic strains of Lactococcus lactis on half-fat Cheddar cheese. Journal of Dairy Science, 93, 3469:3486.

Banks, J. M., Brechany, E. and Christie, W. W. (1989) The production of low fat Cheddar type cheeses. Journal of the Society of Dairy Technology, 42, 6-9.

Guinee, T. P., Fenelon, M. A., Mulholland, E. O., O'kennedy, B. T., O'brien, N. and Reville. W. J. (1998) The influence of milk pasteurization temperature and pH at curd milling on the composition, texture and matuaration of reduced fat Cheddar cheese. International Journal Dairy Technology, 51, 1-10.

Johnson, M. E., Steele, J. L., Broadbent, J. and Weimer, B. C. (1998) Manufacture of Gouda and flavour development in reduced fat Cheddar cheese, Australian Journal Dairy Technology, 2, 67-69.

Beal, P. and Mittal, G. S. (2000) Vibration and compression responses of Cheddar cheese at different fat content and age. Michwissenschaft, 55, 139-142.

Creamer, L. and Olson, N. (1982) Rheological evaluation of maturing Cheddar cheese. Journal of Food Science, 47,632-636.

Madkor, S. A., Tong, P. S. and El Soda, M. (2000a) Evaluation of commercial adjuncts for use in cheese ripening: 5. Effect of added freeze-shocked adjuncts lactobacilli on proteolysis and sensory quality of reduced fat Cheddar cheese. Milchwissenschaft, 55, (7), 382-386.

Pastorino, A. J., Hansen, C. L. and McMahon, D. J. (2003) Effect of pH on the chemical composition and structure-function relationships of Cheddar cheese. Journal of Dairy Science, 86, 2751-2760.

Lane, C. N., Fox, P. F., Johnston, D. E. and McSweeney, P. L. H. (1997) Contribution of coagulant to proteolysis and textural changes in Cheddar cheese during ripening. International Dairy Journal, 7, 453-464.

Kanawjia, S. K., Rajesh, P., Sabikhi, L. and Singh, S. (1995) Flavor, chemical and texture profile changes in accelerated ripened Gouda cheese. Food Science and Technology, 28, 577-583.

1. Production of low fat all natural Cheddar cheese involving the use of exopolysaccharides producing lactobacilli cultures, ripening lactobacilli cultures, and a modified protocol of processing.

2. As mentioned in claim #1, wherein the maximum fat content in the Cheddar cheese after four months of ripening is 10%.

3. As mentioned in claim #1, wherein the Cheddar cheese includes all natural components including: lactic acid bacterial cultures without the addition of non-dairy additives.

4. As mentioned in claim #1, the exopolysaccharides produces lactobacilli cultures.

5. As mentioned in claim #4, wherein the exopolysaccharides producing lactobacilli cultures are classified as capsular, ropy, and unattached, producing strings of about 10 mm when their colonies were touched with a wire loop.

6. As mentioned in claim #1, further comprising selected ripening lactobacilli cultures.

7. As mentioned in claim #6, wherein the selected ripening cultures, composed of a 1:1 mixture of two strains of Lactobacillus paracasei subsp paracasei, and wherein the peptidase system of both Lactobacillus paracasei subsp paracasei is composed of an aminopeptidase N, three dipeptidases, and X-prolydipeptidyl-peptidase, a carboxypeptidase, and a specific endopeptidase, and further includes of a general caseinolytic activity hydrolysing of both αS₁ and β-casein and wherein several esterases releasing C4, C6 and C8 fatty acids were also detected in these Lactobacillus paracasei subsp paracasei.

8. As mentioned in claim #1, wherein a low fat cheddar cheese was produced using a modified protocol of processing.

9. As mentioned in claim #8, wherein the size of the cubes after cutting should have a maximum size of 2×2 cm.

10. As mentioned in claim #8, wherein the cooking temperature is between 35° C. to 39° C.

11. As mentioned in claim #8, wherein the speed and the rate of stirring with maximum of 10 rpm.

12. As mentioned in claim #8, wherein the cheddaring is at a maximum milling pH of 5.8.
